(19) United States
(12) Patent Application Publication
(10) Pub. No.: US 2017/0190194 A1
(43) Pub. Date: Jul. 6, 2017

(54) METHOD TO DETERMINE THE PRINT QUALITY OF AN INKJET PRINTING SYSTEM

(71) Applicant: Océ Holding B.V., Venlo (NL)

(72) Inventors: Werner Zollner, Eitting (DE); Philippe Koerner, Forstinning (DE)

(73) Assignee: Océ Holding B.V., Venlo (NL)

(21) Appl. No.: 15/397,972

(22) Filed: Jan. 4, 2017

(30) Foreign Application Priority Data
Jan. 4, 2016 (DE) 102016100057.4

(51) Int. Cl. B41J 29/393

(52) U.S. Cl. CPC B41J 29/393

(57) ABSTRACT

In a method for determining a print quality of an inkjet printing system, at least one artifact filter is applied to print data to identify a partial region of a print image to be printed in which a print image artifact may be present in the actual printed print image. The print quality of the inkjet printing system can then be determined based on the identified partial region.

### CROSS REFERENCE TO RELATED APPLICATIONS

This patent application claims priority to German Patent Application No. 102016100057.4, filed Jan. 4, 2016, which is incorporated herein by reference in its entirety.

### BACKGROUND

The disclosure is directed to a printing systems and methods, including methods and corresponding systems to determine the print quality of an inkjet printing system.

Inkjet printing systems may be used to print to recording media (such as paper, for example). For this, a plurality of nozzles may be used in order to fire or push ink droplets onto the recording medium, and thus in order to generate a desired print image on the recording medium.

During printing, print quality problems (for example an incorrect positioning of an ink droplet or a nozzle failure) may occur depending on the type of ink that is used and/or depending on the print speed and/or depending on the ejected droplet size per nozzle. For example, these print quality problems arise due to the increase of the viscosity of the ink in the nozzle. In particular, what are known as first line effects—in which print dots may no longer be placed in a targeted manner on the recording medium by a nozzle, or in which the nozzle fails completely—may occur after longer print pauses due to the viscosity change of the ink in a nozzle.

Such printing problems may be detected via the regular printing of test pages or test patterns, for example. In particular, at regular intervals a test pattern may be printed between print job-dependent print images in order to identify print artifacts determined in the analysis of the printed test patterns. However, the printing of test patterns is linked with increased material costs (in particular ink and paper). Furthermore, the printing of test patterns requires an elaborate post-processing since the printed test patterns must be separated (cut out, for example) from the print job-dependent print images.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a block diagram of an inkjet printing system according to an exemplary embodiment of the present disclosure.

FIG. 2 illustrates an inkjet nozzle arrangement according to an exemplary embodiment of the present disclosure.

FIGS. 3a-3d illustrate examples of print image artifacts according to exemplary embodiments of the present disclosure.

FIG. 4 illustrates a workflow diagram of a method to determine the print quality of an inkjet printing system according to an exemplary embodiment of the present disclosure.

FIG. 5a illustrates print artifact filters according to an exemplary embodiment of the present disclosure.

FIG. 5b illustrates print job-dependent print data according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclosure is to detect the print quality of an inkjet printing system in a resource-efficient manner.

The present disclosure includes embodiments of a method for determining the print quality of an inkjet printing system. In an exemplary embodiment, the method includes the analysis, using a first artifact filter, of print data for the printing of a print image to be printed in order to identify a first partial region of the print image to be printed. In operation, a first partial region of a print image that is printed on a recording medium by the inkjet printing system based on the print data may exhibit a print image artifact. In an exemplary embodiment, the method includes the acquisition of sensor data using, for example, an optical sensor. The sensor data can indicate the first partial region of the print image actually printed on the recording medium. In an exemplary embodiment, the method includes the analysis of the print data for the first partial region and the sensor data for the first partial region to determine whether the print image actually printed on the recording medium exhibits a print image artifact in the first partial region.

The present disclosure also includes embodiments of an inkjet printing system. In an exemplary embodiment, the system can include at least one print head for printing a print image on a recording medium, and an optical sensor configured to acquire sensor data with regard to a print image printed on a recording medium. In an exemplary embodiment, the inkjet printing system includes one or more controllers. In an exemplary embodiment, the controller can be configured to analyze print data for the printing of a print image using a first artifact filter to identify a first partial region of the print image in which a print image that is actually printed on the recording medium by the at least one print job based on the print data might exhibit a print image artifact. In an exemplary embodiment, the controller can be configured to induce the optical sensor to acquire sensor data that indicate the first partial region of the print image actually printed on the recording medium. In an exemplary embodiment, the controller can be configured to analyze the print data for the first partial region and the sensor data for the first partial region in order to determine whether the print image actually printed on the recording medium exhibits a print image artifact in the first partial region.

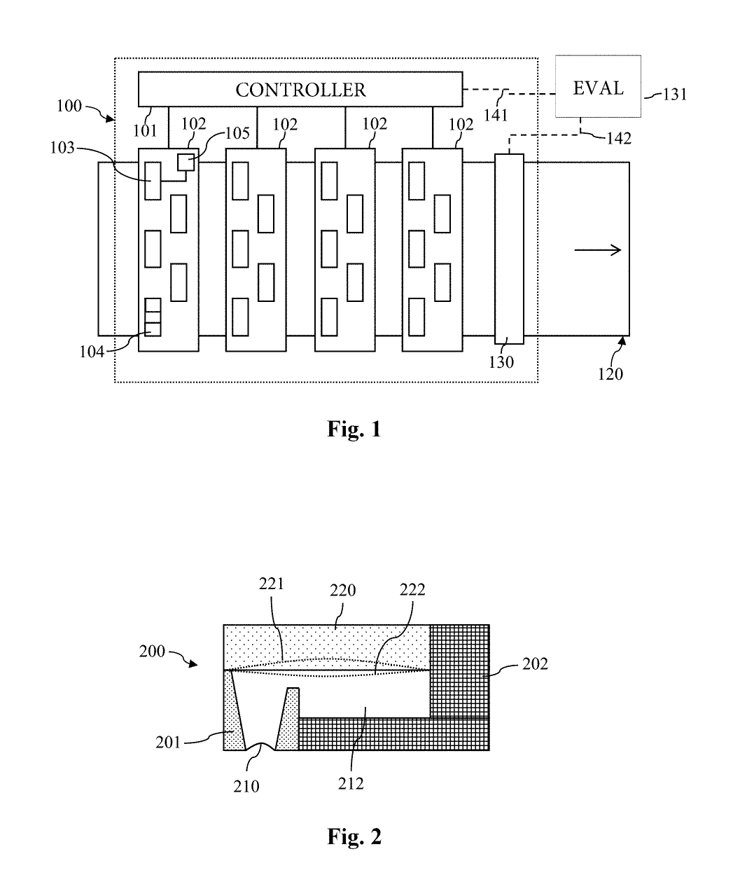

FIG. 1 illustrates a block diagram of an inkjet printing system 100 according to an exemplary embodiment of the present disclosure. In an exemplary embodiment, the printing system 100 is configured to print to a web-shaped recording medium 120 (also designated as a “continuous feed”). However, the embodiments of the present disclosure are also applicable to printing systems configured to print to sheet-shaped recording media (e.g., the system 100 can be configured to print to other types of media, including sheet-shaped media). A web-shaped recording medium 120 is typically unspooled from a roll (the take-off) and then supplied to the print group of the printing system 100. A print image is applied to the recording medium 120 via the print group, and after fixing/drying of the print image the printed recording medium 120 is taken up again on an additional roll (the take-up) or cut into sheets. As illustrated in FIG. 1, the transport direction of the recording medium 120 is represented by an arrow (right direction relative to the drawing). In an exemplary embodiment, the recording medium 120 may be produced from paper, paperboard, cardboard, metal, plastic, textiles and/or other suitable and printable materials.

In an exemplary embodiment, a print group of the printing system 100 comprises four print head arrangements 102 (that are also respectively designated as print bars). The different print head arrangements 102 may be used for printing with inks of different colors (for example black, cyan, magenta and/or yellow). The print group may comprise further additional print head arrangements 102 for printing with additional colors or additional inks (for example MICR ink).

In an exemplary embodiment, a print head arrangement 102 comprises one or more print heads 103. As shown, a print head arrangement 102 comprises five respective print heads 103, but is not limited thereto. Each print head 103 can be subdivided into a plurality of print head segments 104, where each print head segment 104 comprises one or more nozzles or, respectively, nozzle arrangements.

In an exemplary embodiment, the installation position/orientation of a print head 103 within a print head arrangement 102 may depend on the type of print head 103. In an exemplary embodiment, one or more of the print heads 103 includes one or more (e.g., multiple) nozzles or nozzle arrangements that may be arranged in different segments 104. In an exemplary embodiment, each nozzle is configured to fire or spray ink droplets onto the recording medium 120.

In an exemplary embodiment, a print head 103 includes, for example, 2558 effectively utilized nozzles that are arranged along one or more rows transversal to the transport direction of the recording medium 120. In an exemplary embodiment, the nozzles in the individual rows may be arranged offset from one another. A respective line on the recording medium 120 may be printed transversal to the travel direction using the nozzles of a print head 103. An increased resolution may be provided via the use of a plurality of rows with (transversally offset) nozzles. In total, K=12790 droplets may thus be sprayed onto the recording medium 120 along a transversal line by a print head arrangement 102 depicted in FIG. 1 (for example, for a print width of approximately 21.25 inches with 600 dpi (dots per inch). In this example, a print head arrangement 102 can include K (for example K=12790) nozzles for printing of a line (or transversal line) of a print image. Each print head arrangement 102 may thus be set up to print a complete transversal line of a defined color (with K pixels) on the recording medium 120 as needed.

In an exemplary embodiment, the printing system 100 incudes a controller 101 that is configured to activate the actuators of the individual nozzle arrangements of the individual print heads 103 to apply a print image onto the recording medium 120 depending on print data. In an exemplary embodiment, the controller 101 includes processor circuitry configured to perform one or more functions and/or operations of the controller 101, including, for example, activating the actuators.

In an exemplary embodiment, the controller 101 can provide print data rasterized and possibly screened for a print image. In an exemplary embodiment, the controller provides the print data to a controller 105 of the print head arrangement 102, as described below. The print data can indicate (e.g., for every pixel to be printed) whether an ink ejection should take place and/or a droplet size of the ink that is ejected.

In an exemplary embodiment, the printing system 100 includes the controller 105 for a print head arrangement 102 and/or for a print head 103. In an exemplary embodiment, the controller 105 includes one or more Field Programmable Gate Arrays (FPFAs). In an exemplary embodiment, the controller 105 can be configured to activate the individual nozzle arrangements 200 based on the print data. In an exemplary embodiment, the controller 105 is provided as a common controller for a plurality of print heads 103 (e.g., for all print heads 103) of a print head arrangement 102. In an exemplary embodiment, multiple controllers 105 can be included in the system 100 and one or more of the print heads 103 can be associated a corresponding controller 105. In an exemplary embodiment, the controller(s) 105 include processor circuitry configured to perform one or more functions and/or operations of the respective controller 105, including, for example, activating the actuators. In an exemplary embodiment, the controller 105 is an electronic circuit.

In an exemplary embodiment, the printing system 100 includes a control system (not shown in FIG. 1) that is configured to control system superordinate workflows. For example, the control system can control the travel of the recording medium 120 and/or manage the ink supply (in particular of the ink reservoir). In an exemplary embodiment, the controller 101 and/or controller 105 can perform functions and/or operations of the control system.

In an exemplary embodiment, the printing system 100 includes K nozzle arrangements that can be activated with a defined activation frequency to print a line (e.g., transversal to the transport direction of the recording medium 120) with K pixels or K columns on the recording medium 120. In an exemplary embodiment, the activation frequency thereby depends on the print speed (e.g., number of printed lines per time unit) of the printing system 100. In an exemplary embodiment, the nozzle arrangements 200 are immovably or firmly plugged into the printing system 100, and the recording medium 120 is directed at a specific transport velocity past the stationary nozzle arrangements 200.

In an exemplary embodiment, the nozzle arrangement 200 prints a correspondingly determined column (in the transport direction) onto the recording medium 120 (in a one-to-one association). In an exemplary embodiment, at most one ink ejection therefore takes place via a defined nozzle arrangement 200 per line of a print image. The time period in which no ink ejection by a defined nozzle arrangement 200 has taken place consequently results directly from the number of lines in which no “white” pixel is to be printed in a specific column, and from the (possibly constant) print speed. This time may be designated as non-printing time (NPT) or dead time.

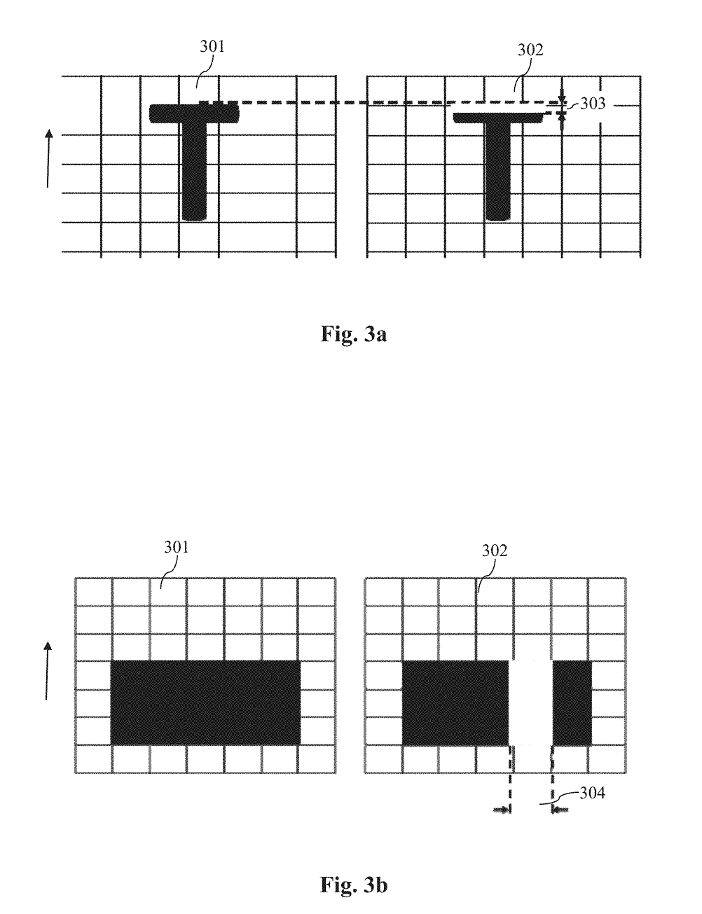

FIG. 2 illustrates a nozzle arrangement 200 of a print head 103 according to an exemplary embodiment of the present disclosure. In an exemplary embodiment, the nozzle arrangement 200 includes walls 202 which, together with an actuator 220 and a nozzle 201, form a receptacle or chamber 212 to receive ink. In operation, an ink droplet may be sprayed or pushed onto the recording medium 120 via the nozzle 201 of the nozzle arrangement 200. The ink forms what is known as a meniscus 210 at the nozzle 201. In an exemplary embodiment, the nozzle arrangement 200 includes an actuator 220 (e.g., a piezoelectric element) that is configured to vary the volume of the chamber 212 to receive ink or, respectively, to vary the pressure in the chamber 212 of the nozzle arrangement 200. For example, the volume of the chamber 212 may be reduced, and the pressure in the chamber 212 increased, by the actuator 220 as a result of a deflection 222. An ink droplet is thus pushed out of the nozzle arrangement 200 via the nozzle 201. FIG. 2 shows a corresponding deflection 222 (dotted line) of the actuator 220. Moreover, the volume of the chamber 212 may be increased via the actuator 220 (see deflection 221) in order to draw new ink into the receptacle or chamber 212 via an inlet (not shown in FIG. 2).

In an exemplary embodiment, the ink 212 within the nozzle arrangement 200 may be moved, and the chamber 212 may be put under pressure, via a deflection 221, 222 of the actuator 220. A defined movement of the actuator 220 thereby produces a correspondingly defined movement of the ink. The defined movement of the actuator 220 can be produced via a corresponding waveform or a corresponding specific pulse of an activation signal of the actuator 220. For example, via a fire pulse (also designated as an ejection pulse) to activate the actuator 220, the nozzle arrangement 200 ejects an ink droplet via the nozzle 201. Different ink droplets may be ejected via different activation signals to the actuator 220. In particular, the ink droplets may thus be ejected with different droplet size (for example 5 pl, 7 pl or 12 pl). In an exemplary embodiment, a prefire pulse (also designated as a pre-ejection pulse) can be used to activate the actuator 220. Although the nozzle arrangement 200 produces a movement of the ink and an oscillation of the meniscus 210 in response to the prefire pulse, no ink droplets are ejected via the nozzle 201.

The viscosity of the ink at the nozzle 201 of a nozzle arrangement 200 may increase due to evaporation. In an exemplary embodiment, prefire pulses are used to counteract an increase in viscosity of the ink. Via a prefire pulse, the actuator 220 of a nozzle arrangement 200 is induced to move the ink within the nozzle arrangement 200 and to bring the meniscus 210 at the nozzle 201 into oscillation such that, although a mixing of the ink within the chamber 212 of the nozzle arrangement 200 occurs, an ejection of ink does not. A prefire pulse thus enables the viscosity of the ink within the nozzle arrangement 200 to be reduced without printing a “non-white” pixel.

As discussed herein, the print quality of an inkjet printing system 100 may be negatively affected by, for example, the change of the viscosity of the ink in a nozzle arrangement 200, the (partial or complete) blockage of a nozzle arrangement 200, the failure of a nozzle arrangement 200, contamination of a nozzle arrangement 200, or one or more other operational conditions as would be understood by one of ordinary skill in the relevant arts.

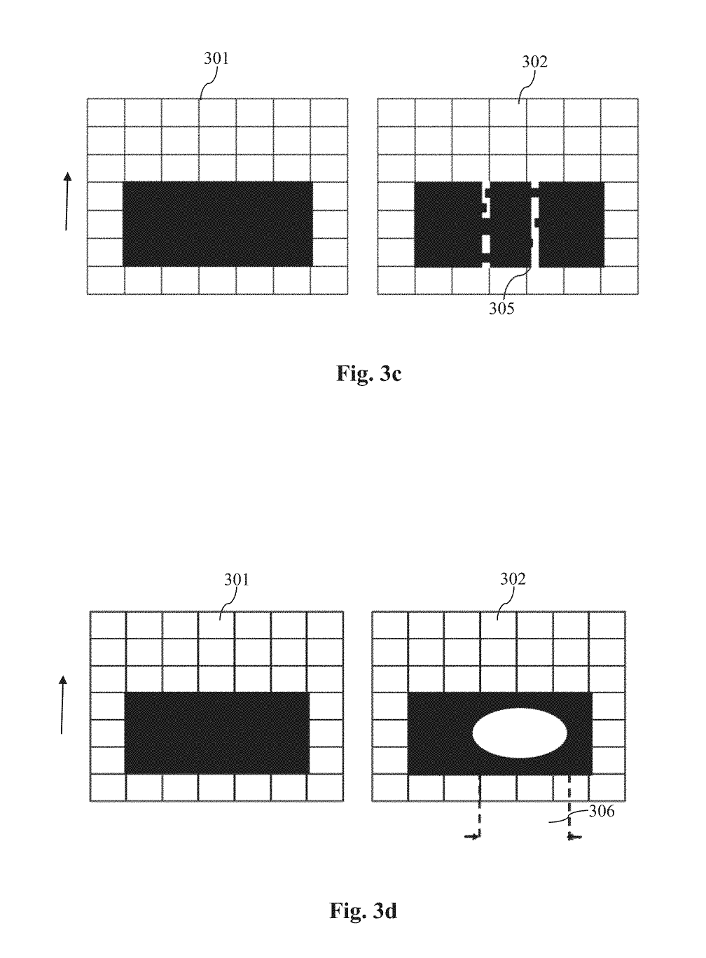

FIGS. 3a, 3b, 3c and 3d illustrate example print image artifacts 303, 304, 305, 306 according to exemplary embodiments of the present disclosure via which the print quality may be reduced. The arrows (e.g., vertical arrows relative to the drawings) indicate the transport direction of the recording medium 120. In these examples, FIGS. 3a, 3b, 3c and 3d show artifact-free print images 301 and negatively affected print images 302. FIG. 3a thereby shows a typical first line effect 303 in which the ink ejection for a first line is negatively affected after a dead time. FIG. 3b shows the generation of a streak 304 along the transport direction on the print image. The streak may be caused by, for example, the failure of a nozzle arrangement 200. FIG. 3c shows an example artifact 305 that is caused by a randomly diverted or deflected ink jet (e.g., due to contaminants in the nozzle 201 and/or of partial blockage of the nozzle 201 of a nozzle arrangement 200). FIG. 3d shows an example of an artifact 306 that may be caused by, for example, a lack of robustness of the recording medium 120. An additional artifact (that is not shown in FIGS. 3a through 3d) may be caused by, for example, an ink droplet that has separated from the surface of a nozzle 201 of a nozzle arrangement 200 without generation of a fire pulse. Such a droplet may, for example, be detected in a white region, or in a region with a color deviating from the color of the ink droplet.

In exemplary embodiments, artifacts, such as print image artifacts 303, 304, 305, 306 may be detected via a comparison of an ideal print image 301 with an actual print image 302. For example, an actual printed print image 302 may be detected by a sensor 130, such as optical sensor 130 (e.g., by a scanner and/or by a camera). The sensor 130 is not limited to optical sensors and can be other types of sensors as would be understood by one of ordinary skill in the art.

The sensor 130 can then be configured to transmit the sensor data 142 to an evaluator 131 (e.g., via a data line between sensor 130 and evaluator 131) that is configured to evaluate the sensor data 142 (see FIG. 1). The print data 141 that indicates the ideal print image 301 may be transmitted to the evaluator 131 from the controller 101 (e.g., via a data line between controller 101 and evaluator 131). In an exemplary embodiment, the evaluator 131 is configured to compare the sensor data 142 and the print data 141 to determine the print quality of the print image. For example, the evaluator 131 can identify print image artifacts 303, 304, 305, 306 in the printed print image 302 based on the comparison. In an exemplary embodiment, the evaluator 131 includes processor circuitry that is configured to perform one or more functions and/or operations of the evaluator 131, such as evaluating the sensor data 142 and/or print data 141, comparing the sensor data 142 and the print data 141, and/or identifying image artifacts. In an exemplary embodiment, the evaluator 131 is, for example, a comparator (e.g., an operational amplifier), a computer, or other circuitry configured to compare two or more input signals (e.g., print data and sensor data) and generate an output signal corresponding to the comparison of the input signals.

To reduce computing resources and/or computing costs to evaluate the entirety of the sensor data 142, such as those in high-capacity printing systems 100 having a continuous feed of a recording medium 120 and/or in systems with real time evaluation, the printing system 100 in one or more exemplary embodiments can be configured to evaluate a subset of the sensor data 142 (e.g., a portion of the sensor data 142 for the complete printed image 302).

A print image 301 may have different partial regions in which the probability of the presence of print image artifacts 303, 304, 305, 306 is of different magnitudes. For example, the presence of a visible first line effect 303 may be formed by the printing of a continuous transversal line (transversal to the transport direction) following a defined dead time. On the other hand, the presence of a streaking 304 may be formed by the printing of a continuous longitudinal line (along the transport direction).

In an exemplary embodiment, an artifact filter may be configured to analyze the print data 141 that indicate the ideal print image 301 to identify one or more partial regions of the ideal print image 301 in which a print image artifact 303, 304, 305, 306 may be present (with a relatively increased probability). That is, an artifact filter can be configured to identify a partial region of a print image 301 in which a print image artifact 303, 304, 305, 306 might be present with relatively high probability (in comparison to other partial regions of print image 301).

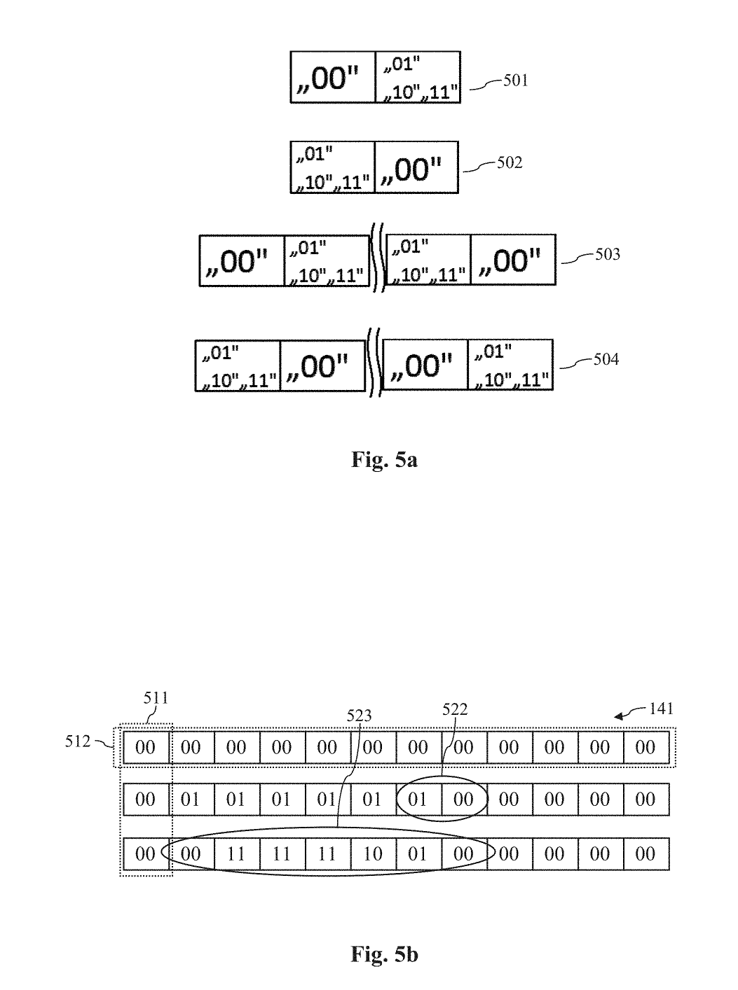

FIG. 5a illustrates example artifact filters 501, 502, 503, 504 according to exemplary embodiments of the present disclosure. The artifact filters 501, 502, 503, 504 can be configured for print data 141 that indicates, for example, with two bits per pixel, whether a “white” pixel (“00”) or a “non-white” pixel having a defined droplet size (“01”, “10” or “11”) should be printed. In an exemplary embodiment, the different bit combinations “01”, “10” or “11” may thereby indicate different droplet sizes (e.g., 7 pl, 9 pl and 12 pl).

In one or more exemplary embodiments, the artifact filter 501 of FIG. 5a can be used to identify a partial region of a print image 301 having a transition from a “white” pixel to a “non-white” pixel. In one or more exemplary embodiments, the artifact filter 502 of FIG. 5a can be used to identify a partial region of a print image 301 having a transition from a “non-white” pixel to a “white” pixel. In one or more exemplary embodiments, the artifact filter 503 of FIG. 5a can be used to identify a partial region having a defined number of contiguous, adjoining “non-white” pixels. In one or more exemplary embodiments, the artifact filter 504 of FIG. 5a can be used to identify a partial region having a defined number of contiguous, adjoining “white” pixels.

In one or more exemplary embodiments, artifact filters 501, 502, 503, and/or 504 can be used to analyze print data 141. FIG. 5b illustrates examples of print data 141 for multiple lines 512 (transversal to the transport direction) and multiple columns 511 (along the transport direction) of a print image 301 according to an exemplary embodiment of the present disclosure. In an exemplary embodiment, an artifact filter 501, 502, 503, 504 may be used to identify a partial region of the print data 301 in which a print image artifact 303, 304, 305, 306 might be present, in particular with a relatively increased probability. For example, the partial region 523 may be identified with the artifact filter 502 of partial region 522 and with the artifact filter 503 of partial region 523.

In an exemplary embodiment, after identifying one or more partial regions 522, 523 using one or more artifact filters 501, 502, 503, 504, the evaluator 131 can evaluate the sensor data 142 of a corresponding actually printed print image 302 by restricting the evaluation to the sensor data 142 for the identified partial regions 522, 523. In this example, the discovery of print image artifacts 303, 304, 305, 306 may be, for example, substantially accelerated and/or using reduced processing resources. In an exemplary embodiment, the printing system 100 (e.g., evaluator 131) can be configured to select relevant partial regions (e.g., regions 522, 534) of the print image 301 to be printed enables the determination of the print quality of an inkjet printing system 100 in real time (even at relatively high print speeds).

In one or more exemplary embodiments, inkjet-relevant print quality patterns 522, 523 are thus detected and selected in the print data 141 of a print image 301 to be printed. Print job-dependent print data 141 may thereby be used, such that the analysis of the print quality may take place using actual print jobs without the need for specific test patterns. In one or more exemplary embodiments, this is enabled in that only partial regions 522, 523 of the print data 141 are selected to determine the print quality, and thus a processing in real time is enabled. A resource-efficient determination of the print quality may thus take place.

In an exemplary embodiment, the print data 141 corresponds to the data that have already been rasterized and obtained from a screening process (to depict continuous tones). In particular, the print data 141 may include control instructions (e.g., a sequence of one or more bits/pixel) for the individual nozzle arrangements 200 of a print bar 102 or of a print head 103. The control instructions can indicate whether a pixel should be printed or not (and with what droplet size, if applicable) by a nozzle arrangement 200 in a specific line (transversal to the transport direction).

In an exemplary embodiment, the controller 101 and/or the controller 105 can be configured to detect and select the artifact-relevant partial regions (e.g., regions 522, 523).

In an exemplary embodiment, the detection and selection of artifact-relevant partial regions 522, 523 may be realized via software (e.g., executed by controller 101 of the printing system 100) and/or via hardware (e.g., by controller 105 of a print head 103). For a partial region 522, 523, the filter type identified for the partial region 522, 523 may be determined and stored in a memory (and, if applicable, what artifact type is to be expected in the partial region 522, 523). Furthermore, the position and/or the extent of the partial region 522, 523 may be determined and stored in a memory. The memory may be included in the printing system 100 (e.g., within controllers 101 and/or 105, within evaluator 131, and/or within one or more other components of the system 100) and/or provided as an external memory that is accessible by the system 100.

The sensor data 142 may then be selectively detected (via the determined position and/or extent of the partial regions 522, 523), evaluated and compared with the print data 141 for these partial regions 522, 523. This may take place in real time due to the restriction to one or more partial regions 522, 523 of a printed print image 302.

Given detection of a print image artifact 303, 304, 305, 306 in a partial region 522, 523, a measure may be initiated for compensation of the print image artifact. In an exemplary embodiment, examples of compensation measures can include, for example (but not limited to): the generation of prefire pulses, the compensation for the failure of a nozzle arrangement 200 via an adjacent nozzle arrangement 200, and/or one or more other compensation measures that would be understood by one of ordinary skill in the art. Quality fluctuations and errors may thus be compensated and/or remedied during the running print operation, if applicable.

In an exemplary embodiment, the data to be printed (e.g., PDF, BMP, image files) may be rasterized to form corresponding raw data, i.e. the print data 141. Each print pixel may be transferred between the controller 101 and the controller 105 for the print heads 103 (also designated as a bar driving board (BDB) with, for example, 2-bit resolution (4 possible droplet sizes). The transfer may thereby take place serially in 2k data blocks, wherein each block is CRC-secured and may be packaged in a protocol (e.g., a Fibre Channel protocol). The rasterized print data 141 for all nozzle arrangements 200 are thus transferred to the BDB 105. The rasterized print data 141 are thus present as digital information in the controller 101 and in the BDB 105. The search for relevant partial regions 522, 523 may thus take place at the controller 101 (e.g., using a software (SW) program) and/or at the BDB 105 (e.g., as a hardware (HW) implementation).

In an exemplary embodiment, specific (digitized) states of the nozzle arrangements 200, or changes in nozzle activities, may be detected in the print image 301 (as partial regions 522, 523) via a comparison or linking (AND, OR, EXOR, . . . ) of the print data 141 with digital patterns or filters 501, 502, 503, 504 (with variable, serialized digital bit information). The determined partial regions 522, 523 (also designated as POIs, points of interest, or “areas of print artifacts”) may be used in the assessment or in the comparison of a recorded camera image (i.e. the sensor data 142) of the actually printed print image 302 as a basis.

In an exemplary embodiment, the print data 141 may include different levels (also designated as planes) for different colors or for different corresponding print head arrangements 102 of the printing system 100. The filters 501, 502, 503, 504 may be applied to each color plane. The filters 501, 502, 503, 504 may be variable in length and content. Different filters 501, 502, 503, 504 may be linked with one another and combined within a line to be printed. The effect of a filter 501, 502, 503, 504 may thereby extend across multiple lines in order to be able to detect and examine a region with identical properties (for example for detection of a solid for nozzle failure detection). Furthermore, filter results of different colors may be combined to detect blurring effects (merging of colors), for example. In particular, filters 501, 502, 503, 504 may be provided that may detect transition regions 522, 523 between different colors on the basis of the print data 141 for multiple color planes.

In an exemplary embodiment, filters 501, 502, 503, 504 enable the targeted examination of print data 141 having different droplet sizes (for example, “00”=>no droplet, “01”=>fire pulses 1, “10”=>fire pulses 2, “11”=fire pulses 3). Filters 501, 502, 503, 504 may be provided that enable a partial region 522, 523 having a specific number of printed pixels/free pixels to be identified.

In an exemplary embodiment, to obtain information about statuses of all nozzle arrangements 200, the application of the filters 501, 502, 503, 504 may be distributed statistically over the entire width of a print image 301. For example, it may be checked, and via corresponding selection of partial regions 522, 523 it may be ensured, that the selected partial regions 522, 523 cover the entire print width (transversal to the transport direction) of the printing system 100.

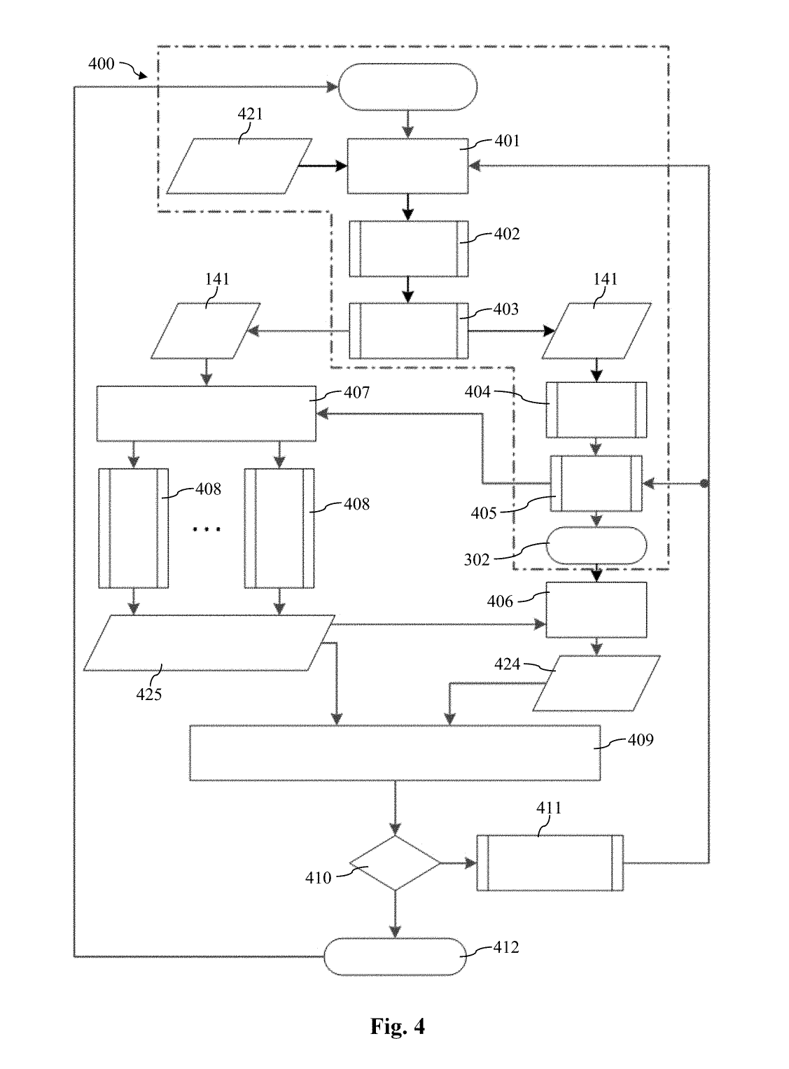

FIG. 4 illustrates a workflow diagram of a method 400 for determining the print quality of an inkjet printing system 100 according to an exemplary embodiment of the present disclosure. In an exemplary embodiment, the method 400 includes the analysis 407, 408 of print data 141 for the printing of a print image 301 to be printed by means of a first artifact filter 501, 502, 503, 504. The print data 141 may be determined on the basis of the data 421 of a print job (for example on the basis of data in a format such as TIF, PDF, BMP etc.). Image data for a print image may be determined from the data 421 (step 401), where the image data are rasterized according to the resolution of the printing system 100 (step 402) and may be screened to generate continuous tones (step 403) to provide the print data 141 for the print image 301 to be printed. The analysis 407, 408 of the print data 141 may take place based on the print data 141 in the controller 101 of the printing system 100 and/or based on the corresponding control data in the controller 105 of a print head 103.

In an exemplary embodiment, at least a first partial region 522, 523 of the print image 301 to be printed may be identified as a result of the analysis of the print data 141. In particular, a first partial region 522, 523 may be identified in which a print image 302 actually printed by the inkjet printing system 100 on a recording medium 120 on the basis of the print data 141 might exhibit a print image artifact 303, 304, 305, 306. In an exemplary embodiment, the first artifact filter 501, 502, 503, 504 is thereby designed such that the probability of the presence of a print image artifact 303, 304, 305, 306 (of at least one defined artifact type) in the identified first partial region 522, 523 is relatively greater than the probability of the presence of a print image artifact 303, 304, 305, 306 in a partial region (in particular in all partial regions) of the print image 302 that has not been identified by the first artifact filter 501, 502, 503, 504. The first artifact filter 501, 502, 503, 504 may thus be set up to identify one or more first partial regions 522, 523 in which the presence of a (visible) print image artifact 303, 304, 305, 306 is especially probable.

In an exemplary embodiment, an artifact filter 501, 502, 503, 504 for identifying partial regions 522, 523 having increased artifact probability may be determined using a machine learning algorithm, for example. In an exemplary embodiment, test partial regions with print image artifacts may be identified using test data having a plurality of (actually printed) test print images. One or more artifact filters 501, 502, 503, 504 may then be determined that enable the test partial regions to be identified with an optimally high probability based on the test print data for the test print images. These one or more artifact filters 501, 502, 503, 504 may then be used in the described method 400 in order to identify one or more partial regions 522, 523 in which a print image artifact 303, 304, 305, 306 is present with relatively high probability.

In an exemplary embodiment, the method 400 additionally includes the detection 406 of sensor data 142 by means of an optical sensor 130. The sensor data 142 thereby indicate at least the first partial region 522, 523 of the print image 302 actually printed on the recording medium 120. The sensor data 142 may possibly indicate only the one or more partial regions 522, 523 that have been identified by means of an artifact filter 501, 502, 503, 504. The expenditure for the detection of sensor data 142 may thus be reduced.

In an exemplary embodiment, the print data 141 may be sent to the controller 105 of the one or more print heads 103 of the printing system 100 (steps 404, 405), and the print heads 103 may print the print image 302 onto a recording medium 120 according to the print data 141. The actually printed print image 302 may then be detected (in at least the first partial region 522, 523) by means of an optical sensor 130 (for example by means of an image and/or line camera). Information 425 with regard to the position and/or the dimensions of the first partial region 522, 523 may be provided to the sensor 130 for this purpose.

In an exemplary embodiment, the method 400 includes the analysis 409 of the print data 141 for the first partial region 522, 523 and the sensor data 142 for the first partial region in order to determine whether the print image 302 actually printed on the recording medium 120 exhibits a print image artifact 303, 304, 305, 306 in the first partial region 522, 523. In particular, the print data 141 for the first partial region 522, 523 may be compared with the sensor data 142 for the first partial region. For example, for the comparison 409 the sensor data 142 for the first partial region 522, 523 may be converted into corresponding pseudo-print data, wherein the pseudo-print data indicate, for a specific pixel, whether an ink droplet has been printed and/or with what droplet size an ink droplet has been printed. For this purpose, a calibration may take place in order to reliably convert the detected print image of a pixel into corresponding pseudo-print data for this pixel. Within the scope of the calibration, it may in particular be considered in which form the ink droplets of different size deposit in the print image on the recording medium 120. The conversion of the sensor data 142 into pseudo-print data may in particular depend on one or more properties of the recording medium 120.

In an exemplary embodiment, the pseudo-print data for the first partial region 522, 523 may then be directly compared with the original print data 141 for the first partial region 522, 523 in order to determine whether a print image artifact 303, 304, 305, 306 is present or not. Furthermore, it may be determined what artifact type is present.

In an exemplary embodiment, alternatively or additionally, sensor data for the entire printed print image 302 may be acquired so that the sensor data 142 indicate the entire print image 302 actually printed on the recording medium 120. The sensor data 142 and the print data 141 may thereby have an identical format that corresponds to pseudo-print data (as presented above). In an exemplary embodiment, the method 400 may then include the analysis of the sensor data 142 by means of the first artifact filter 501, 502, 503, 504 in order to check whether the first artifact filter 501, 502, 503, 504 identifies the first partial region of the sensor data 142. In other words, the first artifact filter 501, 502, 503, 504 may be applied to the print data 141, and thereby supply a print data filter result (for example via identification of the first partial region 522, 523). Analogously, the first artifact filter 501, 502, 503, 504 may be applied to the sensor data 142 and thereby supply a sensor data filter result. The print data filter result and the sensor data filter result may thereupon be compared with one another. In particular, it may be determined whether the print data filter result and the sensor data filter result yield the same one or multiple partial regions 522, 523. If this is the case, no print image artifact 303, 304, 305, 306 (according to the first artifact type) is present.

In an exemplary embodiment, if no print image artifact 303, 304, 305, 306 is present, the printing process may be continued without measures (step 412). On the other hand, the method 400 may include the inducement 411 of a measure to increase the print quality if it is determined that the print image 302 actually printed on the recording medium 120 has a print image artifact 303, 304, 305, 306 in the identified first partial region 522, 523.

In an exemplary embodiment, the method 400 includes the application of at least one artifact filter 501, 502, 503, 504 to the print data 141 of an inkjet printing system 100 to identify a partial region 522, 523 of a print image 301 to be printed in which a print image artifact 303, 304, 305, 306 might (with relatively elevated probability) be present in the actually printed print image 302. The print quality of the inkjet printing system 100 may then be determined on the basis of the identified partial region 522, 523.

The method 400 thus enables the print quality of a printing system 100 to be determined in a resource-efficient manner. In particular, via the selection of one or more partial regions 522, 523 by means of at least one artifact filter 501, 502, 503, 504 it may be achieved that print image artifacts 303, 304, 305, 306 may be identified even in a running print operation, and measures to increase the print quality may be implemented if necessary.

In an exemplary embodiment, the print image artifact 303, 304, 305, 306 that is identified with the first artifact filter 501, 502, 503, 504 may be associated with a first artifact type of a plurality of different artifact types. The first artifact filter 501, 502, 503, 504 may thereby depend on the first artifact type. In particular, the first artifact filter 501, 502, 503, 504 may be designed such that it identifies partial regions 522, 523 that—with particularly high probability—exhibit a print image artifact 303, 304, 305, 306 of the first artifact type. As presented above, such an artifact filter 501, 502, 503, 504 may be determined by means of a machine learning algorithm.

In an exemplary embodiment, artifact types can include, for example (but are not limited to): a “first line” effect transversal to a transport direction of the recording medium 120; a streaking along the transport direction of the recording medium 120; a spatial gap in an inked region of the print image 301 to be printed; a printed location in an un-inked region of the print image 301 to be printed, and/or a merging of ink of different colors (from different print head arrangements 102).

In an exemplary embodiment, the method 400 may additionally include the provision of a plurality of different artifact filters 501, 502, 503, 504 for the corresponding plurality of different artifact types. The individual artifact filters 501, 502, 503, 504 may thereby be determined by means of the aforementioned machine learning algorithm, wherein for this purpose test partial regions that exhibit printing artifacts of a specific artifact type may be determined from test print images. In an exemplary embodiment, an artifact filter may then be determined that filters these test partial regions out from the original print data with especially high probability. In particular, the corresponding test print data of the test partial regions may be considered, and the artifact filter may be determined from the test print data of the test partial regions. For example, the artifact filter may correspond to the typical (for example average) test print data.

In an exemplary embodiment, different artifact filters may thus be determined for different artifact types. The method may then additionally include the selection of the first artifact filter from the plurality of different artifact filters in order to examine the print image actually printed onto the recording medium with relation to print image artifacts of the first artifact type. The use of different artifact filters for different artifact types thus enables a resource-efficient and detailed analysis of the print quality of a printing system. In particular, given knowledge of an artifact type, artifact-specific (and therefore effective) measures may be introduced to increase the print quality.

In an exemplary embodiment, a specific artifact filter 501, 502, 503, 504 may be designed for a specific artifact type, such that the probability of the presence of a print image artifact 303, 304, 305, 306 of the defined artifact type in a partial region 522, 523 that is identified with the specific artifact filter 501, 502, 503, 504 is greater than the probability of the presence of a print image artifact 303, 304, 305, 306 in another partial region of the print image 302 that is actually printed on the recording medium 120, in particular is (on average) greater than the probability of the presence of a print image artifact 303, 304, 305, 306 in any other partial region of the print image 302 that is actually printed on the recording medium 120. Via the use of such artifact filters 501, 502, 503, 504, the print quality of the printing system 100 may be reliably determined even given the use of only a few samples (i.e. of a few partial regions 522, 523). The use of such artifact filters 501, 502, 503, 504 thus enables the resource efficiency to increase further.

In an exemplary embodiment, the method 400 may additionally include the selection of a second artifact filter 501, 502, 503, 504 for a second artifact type from the plurality of different artifact filters 501, 502, 503, 504 in order to examine the print image 302 that is actually printed on the recording medium 120 with regard to print image artifacts 303, 304, 305, 306. The second artifact filter 501, 502, 503, 504 thereby differs from the first artifact filter 501, 502, 503, 504. Furthermore, the method 400 may include the analysis of the print data 141 with the second artifact filter 501, 502, 503, 504 in order to identify a second partial region 522, 523 of the print image 301 to be printed in which the print image 302 that is actually printed on the recording medium 120 might exhibit a print image artifact 303, 304, 305, 306 of the second artifact type. In an exemplary embodiment, moreover, the method 400 may include the acquisition of sensor data 142 that indicate the second partial region 522, 523 of the print image 302 actually printed on the recording medium 120. Print data 141 for the second partial region 522, 523 and the sensor data 142 for the second partial region may then be analyzed (in particular compared with one another) in order to determine whether the print image 302 actually printed on the recording medium 120 exhibits a print image artifact 303, 304, 305, 306 of the second artifact type in the second partial region 522, 523.

In an exemplary embodiment, different artifact filters 501, 502, 503, 504 may be used to identify different artifact types for printed print image 302. The print quality of the printing system 100 may thus be determined in a more precise/differentiated and resource-efficient manner.

In an exemplary embodiment, for each column 511 of the print image 301 to be printed, the inkjet printing system 100 may comprise a dedicated, stationary nozzle arrangement 200. A column 511 thereby runs in the transport direction of the recording medium 120. Furthermore, for a specific column 511 the inkjet printing system 100 may be set up to print the pixels of successive lines 512 of the print image 301 to be printed in chronological succession via the same nozzle arrangement 200 (a line 512 comprises a plurality of columns 511). The lines thereby respectively run transversal to the transport direction of the recording medium 120. For each pixel to be printed by a nozzle arrangement 200, the print data 141 may indicate (for example by means of a binary value) whether an ink ejection should take place and/or what droplet size an ejected ink droplet should have.

In an exemplary embodiment, the use of artifact filters 501, 502, 503, 504 in such printing systems 100 is particularly advantageous since a respective affected nozzle arrangement 200 may be efficiently determined on the basis of the print data 141. Consequently, nozzle arrangements 200 that negatively affect the print quality of the printing system 100 may be efficiently identified using the artifact filters 501, 502, 503, 504.

In an exemplary embodiment, an artifact filter 501, 502, 503, 504 may in particular be configured to identify, based on the print data 141, a partial region 522, 523 in which a transition from one line 512 without ink ejection to a directly following line 512 with ink ejection takes place for a plurality of directly adjacent nozzle arrangements 200. Such an artifact filter 501, 502, 503, 504 may be used to detect a first line effect, for example. Alternatively, an artifact filter 501, 502, 503, 504 may be set up to identify—on the basis of the print data 141—a partial region 522, 523 in which an ink ejection 512 for a number of lines 512 in direct succession takes place for a plurality of directly adjacent nozzle arrangements 200, which number of lines 512 is greater than or equal to a predefined count threshold (for example 5, 10, 20 or more lines 512). Such an artifact filter 501, 502, 503, 504 may be used to detect streaking (in the transport direction), for example.

In an exemplary embodiment, the print data 141 for each pixel of the print image 301 to be printed may include a value from a predefined value set (for example a value set of binary values) that indicates whether an ink ejection should take place and/or what droplet size an ejected ink droplet should have so that a two-dimensional print image matrix results with the values for the different pixels. In an exemplary embodiment, an artifact filter 501, 502, 503, 504 may include a search matrix with values from the predefined value set. The search matrix thereby has fewer columns and/or rows than the print image matrix. The analysis 407, 408 of the print data 141 may then include the identification of a partial region 522, 523 of the print image matrix that corresponds to the search matrix. “Matches” between search matrix and partial regions of the print image matrix may thus be efficiently sought in order to identify a relevant partial region 522, 523 of the print image 301 to be printed.

In an exemplary embodiment, the print image 301 to be printed may be part of a print job to be produced by the inkjet printing system 100. In particular, the print image 301 to be printed may include no test pattern for regeneration and/or for verification of the inkjet printing system 100. The use of an artifact filter 501, 502, 503, 504 enables the print quality of the printing system 100 to be determined directly on the basis of the print job-dependent print data 141, such that the resource consumption for the printing of dedicated test patterns may be spared.

In an exemplary embodiment, the inkjet printing system 100 includes at least one print head 103 for printing a print image 302 on a recording medium 120. Furthermore, the inkjet printing system 100 comprises an optical sensor 130 to acquire sensor data 142 with regard to a print image 302 printed on the recording medium 120. Moreover, the printing system comprises controller 101, controller 105 and evaluator 131 that are configured to individually or cooperatively execute the method 400 described in this document.

In an exemplary embodiment, via the described measures, the quality of a printing system 100 may be determined without use of test patterns during the continuous printing operation of print jobs. No elaborate post-processing is thus required to remove the print jobs (in particular given web-shaped recording media 120). Furthermore, the ink consumption/paper consumption may be reduced. Moreover, the productivity of the printing system 100 may be increased. The computing costs may be flexibly adapted to quality requirements via a suitable selection of the artifact filters 501, 502, 503, 504. In particular, the computing costs (and costs of the printing system 100 that are linked with these) may be substantially reduced via a suitable selection of the artifact filters. Furthermore, the described method 400 may be efficiently implemented at pre-existing printing systems 100.

### Conclusion

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, “processor circuitry” can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### Reference List

100 printing system
101 controller of the printing system 100
102 print head arrangement/print bar
103 print head
104 print head segment
105 controller of a print head arrangement
120 recording medium
130 optical sensor
131 evaluator
141 (rasterized and/or “screened”) print data
142 sensor data
200 nozzle arrangement
201 nozzle
202 wall
210 meniscus
212 chamber
220 actuator (piezoelectric element)
221, 222 deflection of the actuator
301 ideal print image
302 print image with artifact
303, 304, 305, 306 print image artifacts
400 method to determine the print quality of an inkjet printing system
401, 402, 403, 404, 405, 406, 407, 408, 409, 410, 411, 412 method steps
421 print job data
425 information regarding an identified partial region
501, 502, 503, 504 artifact filter
511 columns (along the transport direction)
512 line (transversal to the transport direction)
522, 523 partial regions identified with artifact

1. A method adapted to determine the print quality of an inkjet printing system, the method comprising:
analyzing, using a first artifact filter, print data for printing of a print image to be printed to identify a first partial region of the print image to be printed in which a print image printed on a recording medium by the inkjet printing system based on the print data may exhibit a print image artifact;
acquiring sensor data, using an optical sensor, the sensor data indicating a printed partial region of the print image printed on the recording medium, wherein the first partial region corresponds to the printed partial region; and
analyzing the print data for the first partial region and the sensor data for the printed partial region to determine whether the print image printed on the recording medium exhibits the print image artifact in the printed partial region.

2. The method according to claim 1, wherein:
the print image artifact is associated with a first artifact type of a plurality of different artifact types;
the plurality of different artifact types include:
a first line effect transversal to a transport direction of the recording medium;
a streak along the transport direction of the recording medium;
a spatial gap in an inked region of the print image to be printed; and/or
a printed location in an un-inked region of the print image to be printed;
a merging of ink of different colors; and
the first artifact filter is based on the first artifact type.

3. The method according to claim 2, further comprising:
provisioning a plurality of different artifact filters for the corresponding plurality of different artifact types; and
selecting the first artifact filter from the plurality of different artifact filters to examine the print image printed on the recording medium based on the print image artifact of the first artifact type.

4. The method according to claim 3, wherein the method comprising:
selecting a second artifact filter for a second artifact type from the plurality of different artifact filters to examine the print image printed on the recording medium based on a print image artifact of the second artifact type, the second artifact filter being different from the first artifact filter;
analyzing the print data using the second artifact filter to identify a second partial region of the print image to be printed in which the print image printed on the recording medium may exhibit a print image artifact of the second artifact type;
acquiring sensor data that indicates a second printed partial region of the print image printed on the recording medium; and
analyzing the print data for the second partial region and the sensor data for the second printed partial region to determine whether the print image printed on the recording medium exhibits the print image artifact of the second artifact type in the second printed partial region.

5. The method according to claim 3, wherein an artifact filter of the plurality of different artifact filters for a corresponding one of the plurality of different artifact types is configured such that a probability of a presence of a print image artifact of the corresponding artifact type is greater in a partial region identified with the artifact filter than in another partial region of the print image printed on the recording medium.

6. The method according to claim 5, wherein the method comprising:
selecting a second artifact filter for a second artifact type from the plurality of different artifact filters to examine the print image printed on the recording medium based on a print image artifact of the second artifact type, the second artifact filter being different from the first artifact filter;
analyzing the print data using the second artifact filter to identify a second partial region of the print image to be printed in which the print image printed on the recording medium may exhibit a print image artifact of the second artifact type;
acquiring sensor data that indicates a second printed partial region of the print image printed on the recording medium; and
analyzing the print data for the second partial region and the sensor data for the second printed partial region to determine whether the print image printed on the recording medium exhibits the print image artifact of the second artifact type in the second printed partial region.

7. The method according to claim 1, wherein:
the inkjet printing system comprises a dedicated, stationary nozzle arrangement for each column of the print image to be printed, the columns running in the transport direction of the recording medium;
for a specific column, pixels of successive lines of the print image to be printed are printed in chronological succession by a same nozzle arrangement, the lines respectively running transversal to the transport direction of the recording medium;
print data for each pixel to be printed by the nozzle arrangement indicate whether an ink ejection should take place and/or a droplet size of an ejected ink droplet.

8. The method according to any of the claim 7, wherein:
the print data for each pixel of the print image to be printed comprises a value from a predefined value set that indicates whether an ink ejection should take place and/or a droplet size an ejected ink droplet to generate a two-dimensional print image matrix including the values for each of the pixels;
an artifact filter comprises a search matrix with values from the predefined value set;
the search matrix includes fewer columns and/or rows than the print image matrix; and
the analyzing the print data comprises identifying a partial region of the print image matrix that corresponds to the search matrix.

9. The method according to claim 8, wherein an artifact filter is configured to identify a partial region based on the print data, wherein:
a transition from one line without ink ejection to a directly following line with ink ejection takes place for a plurality of directly adjacent nozzle arrangements; and/or
for a plurality of directly adjacent nozzle arrangements, an ink ejection is performed for a number of lines in direct succession, the number of lines being greater than or equal to a predefined number threshold.

10. The method according to any of the claim 9, wherein:
the print data for each pixel of the print image to be printed comprises a value from a predefined value set that indicates whether an ink ejection should take place and/or a droplet size an ejected ink droplet to generate a two-dimensional print image matrix including the values for each of the pixels;
an artifact filter comprises a search matrix with values from the predefined value set;
the search matrix includes fewer columns and/or rows than the print image matrix; and
the analyzing the print data comprises identifying a partial region of the print image matrix that corresponds to the search matrix.

11. The method according to claim 1, wherein:
the print image to be printed is part of a print job to be produced by the inkjet printing system; and/or
a test pattern for regeneration and/or verification of the inkjet printing system is absent from the print image to be printed.

12. The method according to claim 1, wherein:
the sensor data indicates the entirety of the print image printed on the recording medium;
the sensor data and the print data have an identical format; and
the method comprises analyzing the sensor data using the first artifact filter to check whether the first artifact filter identifies the printed first partial region of the sensor data.

13. A computer program product embodied on a computer-readable medium comprising program instructions, when executed, causes a processor to perform the method of claim 1.

14. An apparatus of an inkjet printing system configured to perform the method of claim 1.

15. A print quality determination method, comprising:
analyzing, using an artifact filter, print data of a print image that is to be printed to identify a partial region of the print image to be printed;
optically sensing sensor data associated with a printed partial region of the print image that has been printed on the recording medium; and
comparing the print data for the partial region and the sensor data for the printed partial region to determine whether the print image printed on the recording medium exhibits a print image artifact in the printed partial region.

16. The method according to claim 15, wherein the partial region corresponds to the printed partial region.

17. A computer program product embodied on a computer-readable medium comprising program instructions, when executed, causes a processor to perform the method of claim 15.

18. An apparatus of an inkjet printing system configured to perform the method of claim 15.

19. An inkjet printing system, comprising:
at least one print head configured to print a print image on a recording medium;
an optical sensor configured to acquire sensor data corresponding to a print image printed on the recording medium; and
a controller that is configured to:
analyze, using a first artifact filter, print data for the printing of the print image to identify a first partial region of the print image in which a print image printed by the at least one print head onto the recording medium based on the print data may exhibit a print image artifact;
control the optical sensor to acquire sensor data that indicates a printed partial region of the print image printed on the recording medium; and
analyze the print data for the first partial region and the sensor data for the printed partial region to determine whether the print image printed on the recording medium exhibits the print image artifact in the printed partial region.
